(19) United States
(12) Patent Application Publication
(10) Pub. No.: US 2026/0246870 A1
(43) Pub. Date: Aug. 20, 2026

(54) SYSTEMS AND METHODS FOR IDENTIFYING A TIME OF INTERVENTION DURING A CUSTOMER CALL

(71) Applicant: Verizon Patent and Licensing Inc., Basking Ridge, NJ (US)

(72) Inventors: Durgesh KUMAR, Bangalore (IN); Ravi HS, Bangalore (IN); Santosha Banapura Hire MATH, Kuvempunagar (IN); Saurabh TAHILIANI, Noida (IN); Tanmoy GAYEN, Bangalore (IN)

(73) Assignee: Verizon Patent and Licensing Inc., Basking Ridge, NJ (US)

(21) Appl. No.: 19/057,464

(22) Filed: Feb. 19, 2025

(51) Int. Cl. H04M 3/51; G10L 15/22

(52) U.S. Cl. CPC H04M 3/5133; G10L 15/22

(57) ABSTRACT

A device may receive live call data from a customer service call, and may preprocess the live call data to generate utterances. The device may identify call phases associated with the utterances using natural language processing techniques, and may refine the call phases using a multilayer perceptron model to classify the utterances into classified call phases. The device may generate a session vector, a customer vector, and an agent activity vector based on the classified call phases, and may estimate a time of intervention for agent intervention using the session vector, the customer vector, the agent activity vector, and a call phase time modifier. The device may derive an optimal intervention point based on the time of intervention, and may provide a recommendation for agent intervention during the customer service call at the optimal intervention point.

### BACKGROUND

Call centers often serve as the critical interface between customers and companies, impacting customer satisfaction and retention. In telecommunications, as well as other industries, agents are tasked with addressing customer concerns and leveraging opportunities to retain or even upsell to the customer.

### BRIEF DESCRIPTION OF THE DRAWINGS

FIGS. 1A-1G are diagrams of an example associated with identifying a time of intervention during a customer call.

FIG. 2 is a diagram of an example environment in which systems and/or methods described herein may be implemented.

FIG. 3 is a diagram of example components of one or more devices of FIG. 2.

FIG. 4 is a flowchart of an example process for identifying a time of intervention during a customer call.

### DETAILED DESCRIPTION OF EXAMPLE EMBODIMENTS

The following detailed description of example implementations refers to the accompanying drawings. The same reference numbers in different drawings may identify the same or similar elements.

A significant challenge with call centers is the subjective nature of interventions made by agents during customer interactions. Each customer is unique, and the timing and type of interventions (i.e., providing offers, resolutions, and/or the like) can vary greatly from one agent to another, which lacks standardization and can result in inconsistencies in customer experience. Another issue is the lack of proactive agent coaching. While agents may excel at customer service, they often require guidance on how to effectively cross-sell or upsell. Notably, a high percentage of offers made by agents are rejected by customers. This high rejection rate, even when relevant offers are made, suggests that there are unrecognized opportunities for enhancing the intervention timing, quality of the pitch, and overall engagement strategy. Moreover, call centers lack efficient mechanisms for evaluating the timing and content of agent interventions to provide a personalized and empathetic customer service experience. This lack of targeted intervention strategies can lead to increased customer frustration, reduced customer loyalty, and ultimately, a measurable impact on the company's bottom line in terms of lost revenue from potential cross-sell and upsell opportunities. Thus, current techniques for managing call centers consume computing resources (e.g., processing resources, memory resources, communication resources, and/or the like), networking resources, and/or other resources associated with failing to provide appropriate interventions at the correct times, having offers consistently rejected by customers, handling customer complaints and lost customers, and/or the like.

Some implementations described herein provide a management system that identifies a time of intervention during a customer call. For example, the management system may receive live call data from a customer service call, and may preprocess the live call data to generate utterances. The management system may identify call phases associated with the utterances using natural language processing techniques, and may refine the call phases using a multilayer perceptron model to classify the utterances into classified call phases. The management system may generate a session vector, a customer vector, and an agent activity vector based on the classified call phases, and may estimate a time of intervention for agent intervention using the session vector, the customer vector, the agent activity vector, and a call phase time modifier. The management system may derive an optimal intervention point based on the time of intervention, and may provide a recommendation for agent intervention during the customer service call at the optimal intervention point.

In this way, the management system identifies a time of intervention during a customer call. For example, the management system may optimize the timing of agent interventions during customer service calls through data-driven techniques. The management system may enhance the objectivity and precision of agent interventions during customer service calls by utilizing algorithmically-computed intervention points. The approach utilized by the management system may account for the dynamic variables present in each call, including unique customer and agent behaviors, and real-time call flow. The management system may provide an optimized customer service process and improved evaluation metrics via evidence-based intervention recommendations. By automating this aspect of the call handling process, the management system may streamline intervention timings, reduce cognitive load on agents, and minimize the likelihood of errors due to subjective judgment. Thus, the management system may conserve computing resources, networking resources, and/or other resources that would have otherwise been consumed by failing to provide appropriate interventions at the correct times, having offers consistently rejected by customers, handling customer complaints and lost customers, and/or the like.

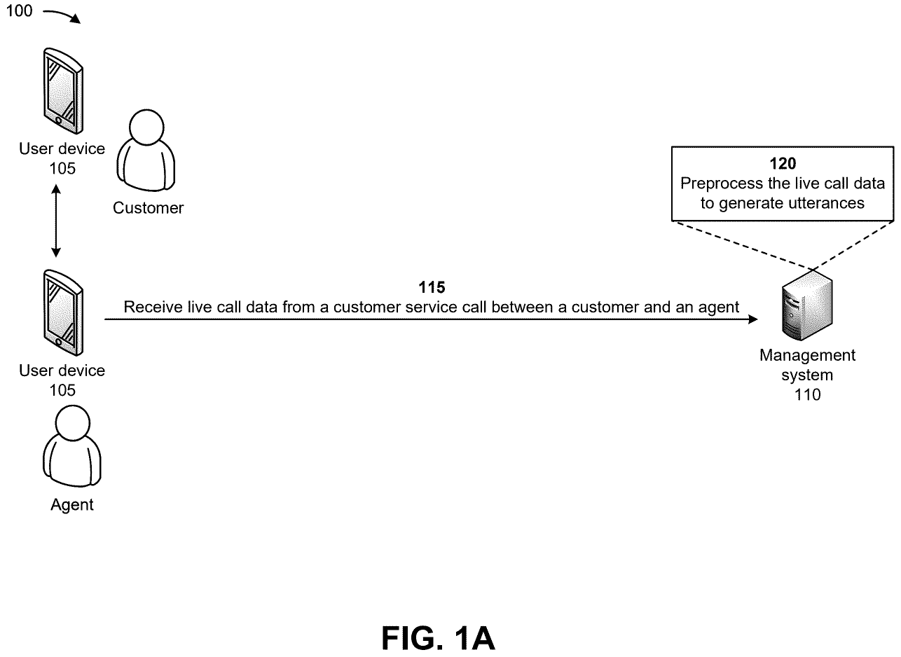

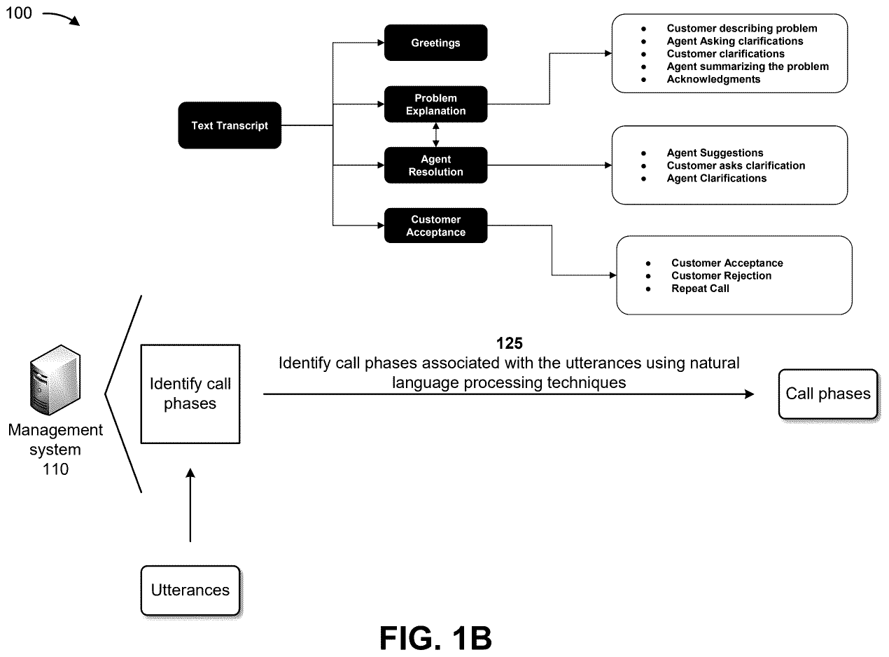

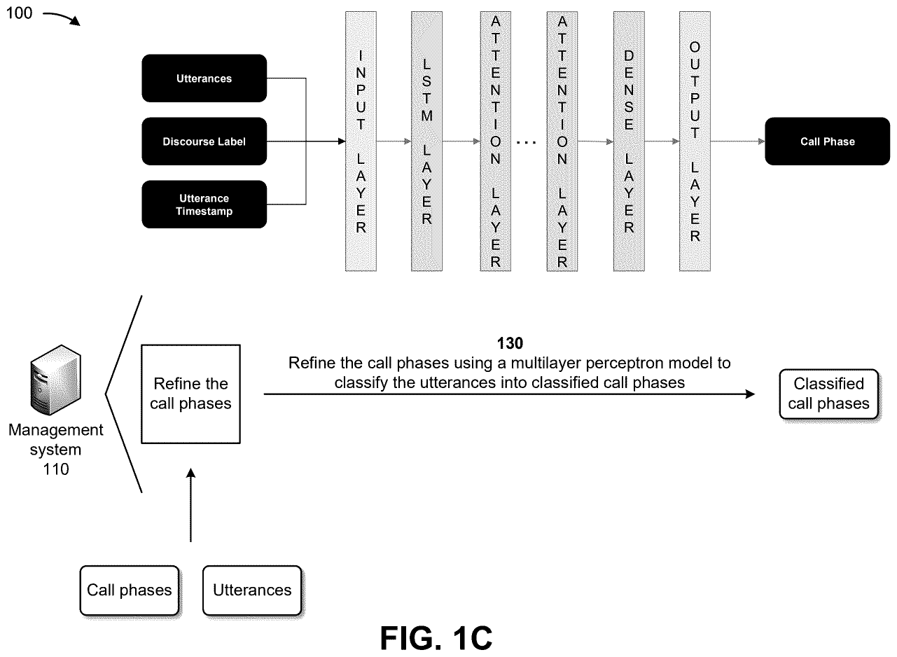

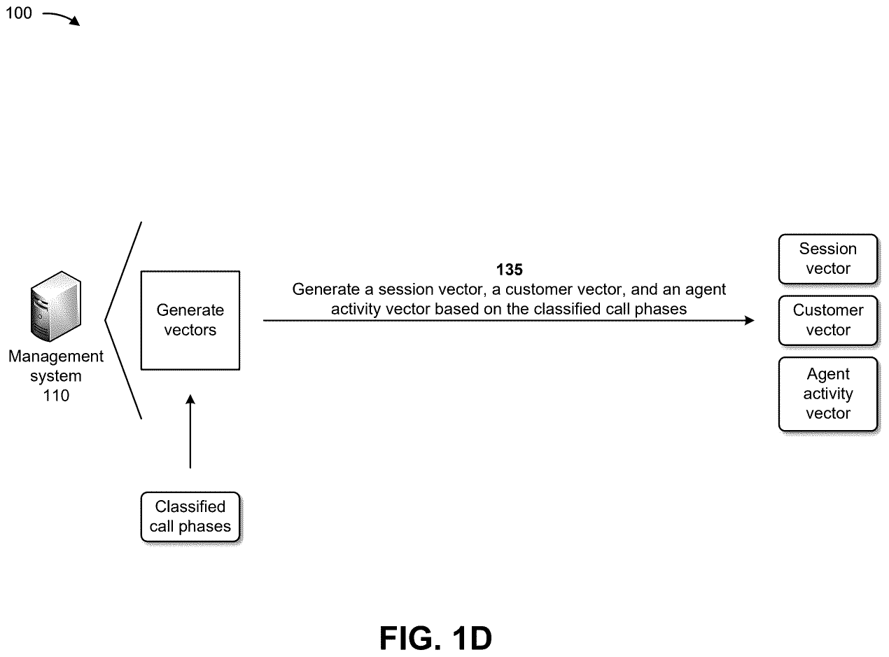

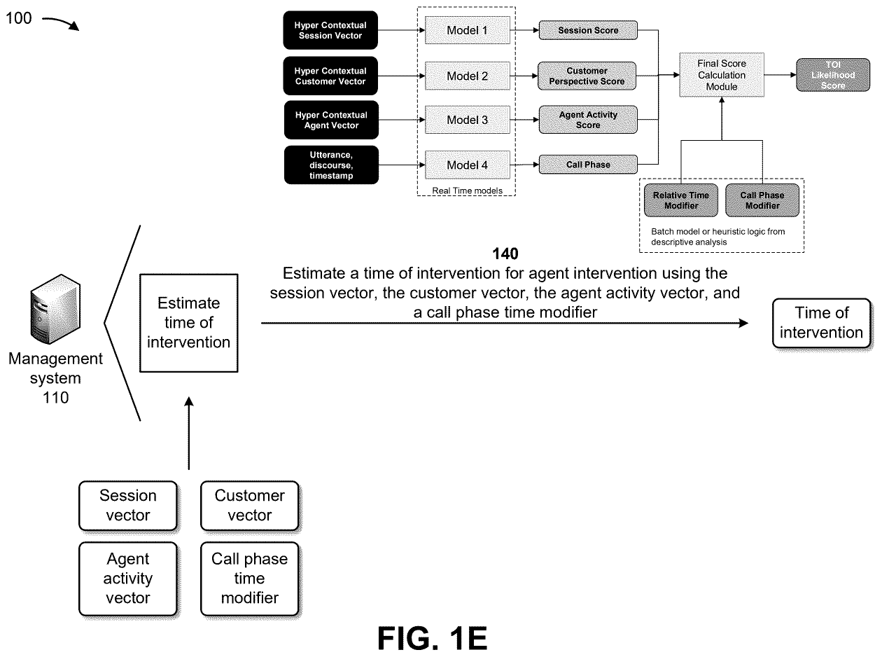

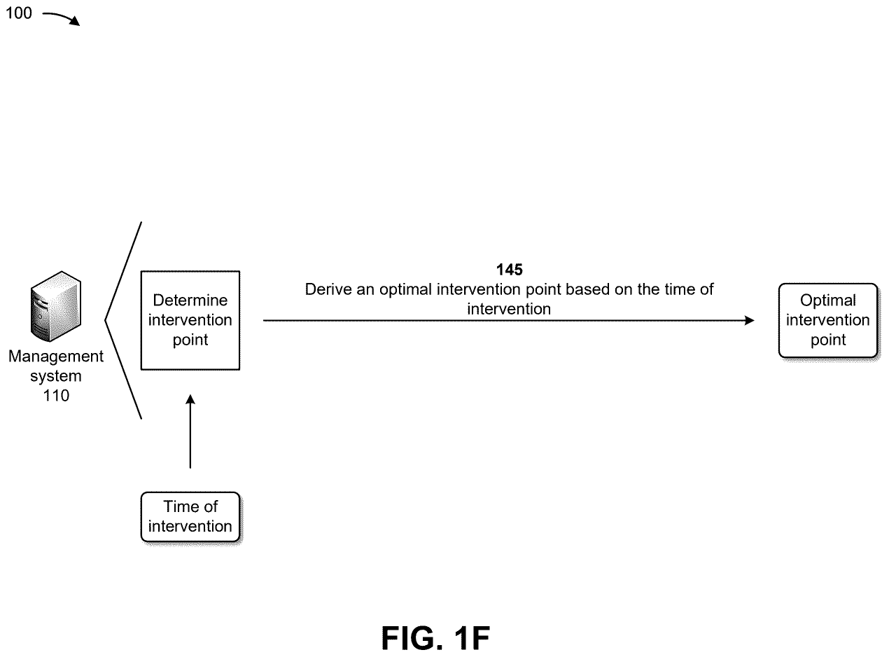

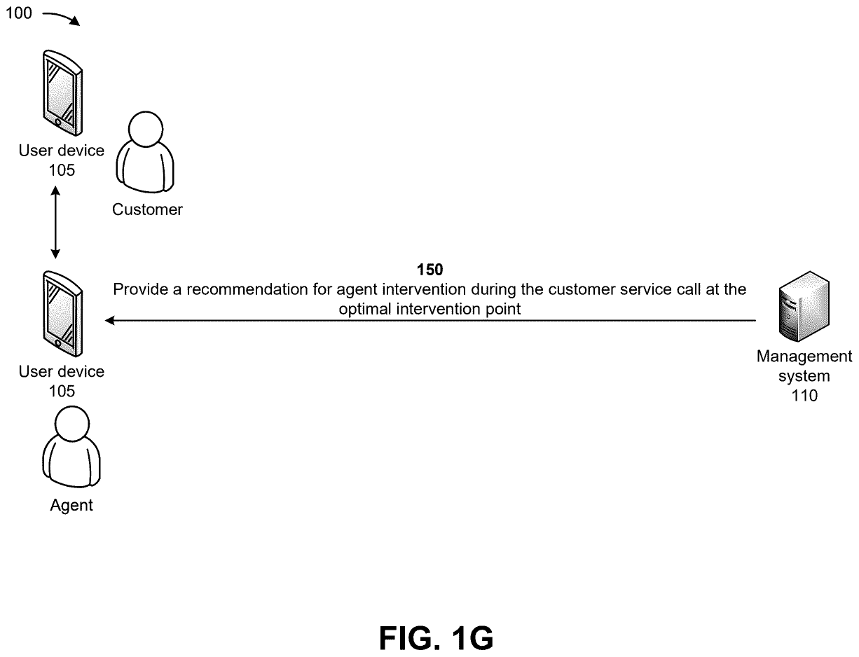

FIGS. 1A-1G are diagrams of an example 100 associated with identifying a time of intervention during a customer call. As shown in FIGS. 1A-1G, the example 100 includes a user device 105 associated with a management system 110. The user device 105 may be associated with an agent that is conducting a call with a customer via another user device 105. The management system 110 may include a system that identifies a time of intervention during a customer call. Further details of the user device 105 and the management system 110 are provided elsewhere herein. Although implementations described herein depict a single user device 105, in some implementations, the management system 110 may be associated with multiple user devices 105. Furthermore, although implementations described herein relate to customer service calls, in some implementations, the management system 110 may be utilized with other customer service interactions, such as a live chat, chatbots, text messaging, video calls, and/or the like.

As shown by FIG. 1A, and by reference number 115, the management system 110 may receive live call data from a customer service call between a customer and an agent. For example, the agent and the customer may conduct a customer service call via the user devices 105, and live call data may be generated during the customer service call. The user device 105 associated with the agent may transmit the live call data to the management system 110 during the customer service call. The live call data may include audio data, metadata, and/or other relevant information exchanged between the customer and the agent during the call. The live call data may enable the management system 110 to analyze the interaction and identify key points for possible intervention. In some implementations, the management system 110 may continuously receive the live call data from the customer service call, may receive the live call data from the customer service call based on requesting the live call data from the user device 105 associated with the agent, and/or the like.

In some implementations, the live call data transmitted by the user device 105 to the management system 110 may be formatted as JSON (JavaScript Object Notation), XML (eXtensible Markup Language), or another standard data format, allowing for seamless integration with existing telecommunication and data analysis systems. For example, the call data JSON format may include fields such as {“callID”: “12345”, “agentID”: “67890”,“audioData”: “base64_encoded_string”, “metadata”: {“duration”: 300, “timestamp”: “2023-04-01T12:00:00Z”}}.

As further shown in FIG. 1A, and by reference number 120, the management system 110 may preprocess the live call data to generate utterances. For example, the management system 110 may convert the audio data into textual representations, commonly referred to as utterances. The preprocessing may include the management system 110 utilizing speech-to-text conversion technology to transcribe the spoken conversation into text. Additionally, the preprocessing may include the management system 110 performing noise reduction on the audio data, segmentation of the textual data, and normalization of the textual data to prepare the textual data (e.g., the utterances) for subsequent analysis. The segmentation of textual data may include dividing a text into smaller, meaningful parts or segments, such as sentences, words, paragraphs, clauses, entities, topics, sentiments, and/or the like. By generating utterances from the live call data, the management system 110 can effectively analyze the content and context of the conversation to make informed decisions about potential interventions.

In some implementations, the preprocessing of the live call data may include using automatic speech recognition (ASR) systems that transform audio inputs into textual data. The management system 110 may utilize ASR models, such as the DeepSpeech or Kaldi frameworks, which have demonstrated high accuracies in various customer service scenarios. The speech-to-text conversion may be enhanced by utilizing noise reduction algorithms, such as spectral subtraction or Wiener filtering, to ensure the clarity of utterances despite environmental noise present during the call.

As shown in FIG. 1B, and by reference number 125, the management system 110 may identify call phases associated with the utterances using natural language processing techniques. For example, the management system 110 may analyze the utterances of the live call data to determine various phases of the call. The management system 110 may identify the call phases based on the content and context of the utterances using natural language processing techniques, such as parsing and text analysis. The identified call phases may include a greetings phase, a problem explanation phase, an agent resolution phase, a customer acceptance or rejection phase, and/or the like. In some implementations, each call phase may further include specific activities or components, such as a customer describing a problem, an agent asking for clarifications, customer clarifications, agent suggestions, and/or the like. For example, a problem explanation call phase may include the customer detailing a problem and the agent summarizing and acknowledging the problem. In other implementations, the agent resolution call phase may include the agent providing solutions and the customer asking for further details. Parsing the utterances may include identifying keywords and phrases characteristic of each call phase, such as a customer's complaint keywords during the problem explanation phase.

In some implementations, the natural language processing techniques may recognize transitional phrases that signal the end of one phase and the beginning of another phase, such as moving from the problem explanation phase to the agent resolution phase. Additionally, or alternatively, the management system 110 may use the natural language processing techniques to segment the utterances into various call phases. The segmentation may include analyzing the sentiments behind utterances to understand the customer's acceptance level.

Moreover, the natural language processing techniques used for identifying the call phases may include named entity recognition (NER), sentiment analysis, and dependency parsing. Specifically, the application of spaCy or the natural language toolkit (NLTK) may help to parse the utterances and identify key phrases, intents, and entities relevant to determining call phases. The spaCy library's dependency parser and sentiment analysis tools may enable the management system 110 to classify text segments into phases such as greetings, problem explanation, resolution, and customer acceptance or rejection phases.

The natural language processing techniques employed by the management system 110 may utilize machine learning frameworks, such as TensorFlow or PyTorch. For example, the initial transcription of audio data to text may leverage a pre-trained “bidirectional encoder representations from transformers” (BERT) model available through TensorFlow Hub, which can be further fine-tuned for specific domain terminology encountered in customer service interactions.

As shown in FIG. 1C, and by reference number 130, the management system 110 may refine the call phases using a multilayer perceptron model to classify the utterances into classified call phases. For example, the management system 110 may be associated with a multilayer perceptron model. A multilayer perceptron model may include a type of artificial neural network specifically designed for supervised learning tasks, such as classification and regression. A multilayer perceptron model is characterized by a layered structure that includes at least three layers: an input layer, one or more hidden layers, and an output layer. Each layer may include multiple neurons (or nodes) that are interconnected and work together to transform input data to output responses. The input layer may include nodes (neurons) that receive various inputs (e.g., features) from a dataset. Each input node may represent a different attribute or feature of the data. The input layer may pass the input values to the next layer without applying any transformations. The hidden layers may perform most of the computations in a multilayer perceptron model. These layers are “hidden” because they are not directly exposed to the input or the output. Each hidden layer may include multiple neurons. Each neuron within a hidden layer may receive a combination of outputs from a previous layer, may apply a weighted summation, may add a bias term, and may pass the result through an activation function which introduces non-linearity. The output layer may receive the processed signals from the last hidden layer and may transform the processed signals into a final output (predictions). A number of neurons in the output layer may depend on the type of task. For example, binary classification typically includes one neuron (using a sigmoid activation function), while multi-class classification includes as many neurons as there are classes (often using a softmax activation function). During training, the multilayer perceptron model may utilize backpropagation to adjust weights and biases in order to minimize the differences between predicted outputs and actual labels.

In some implementations, the management system 110 may utilize the multilayer perceptron model to refine the call phases by taking the utterances as inputs and classifying the utterances into specific call phases. The input layer may receive the utterances, the hidden layers may process the utterances using learned weights and activation functions, and the output layer may assign each utterance to a specific call phase category (e.g., a greeting phase, a problem explanation phase, a resolution phase, an acceptance/rejection phase, and/or the like). Through training on historical call data, the multilayer perceptron model may learn to accurately identify and classify phases in live call data, enhancing an ability of the management system 110 to recommend optimal intervention points during a customer call.

In some implementations, the management system 110 may receive the utterances, discourse labels, and utterance timestamps as input. The utterances may represent the textual data generated from the spoken conversation between the customer and the agent. The discourse labels may classify the utterances into different categories, such as statements, questions, acknowledgements, and/or the like. The utterance timestamps may indicate when each utterance occurred during the call. In some implementations, refining the call phases may include the management system 110 preprocessing the received utterances using tokenization and discourse analysis to generate classified call phases. For example, tokenization may include the management system 110 breaking down the utterances into smaller, manageable components, while discourse analysis may include the management system 110 identifying the structure and functions of the components within the conversation.

In some implementations, the management system 110 may utilize the multilayer perceptron model that includes various neural network layers to process the input (e.g., the utterances, the discourse labels, and the utterance timestamps). Specifically, the multilayer perceptron model may include an input layer, a long short-term memory (LSTM) layer, multiple attention layers, a dense layer, and an output layer. The input layer of the multilayer perceptron model may receive the utterances, the discourse labels, and the utterance timestamps, and may process them sequentially through the LSTM layer, which specializes in handling sequential data. The attention layers may enable the multilayer perceptron model to focus on important parts of the input by assigning higher importance to relevant sections of the utterances. The dense layer may aggregate features extracted by the previous layers to produce a final classification output. The output layer of the multilayer perceptron model may provide the classified call phases, allowing the management system 110 to systematically identify the phases of the call based on the input utterances.

The multilayer perceptron model may be generated through extensive training on historical call data sets obtained from customer service operations spanning several months. Each training instance may include transcribed call text labeled with corresponding call phases. The training process may incorporate backpropagation and stochastic gradient descent to minimize classification error. The network architecture may include three hidden layers (e.g., with 128, 64, and 32 neurons, respectively), each using ReLu (rectified linear unit) activation functions, and an output layer operating with a softmax function to determine call phase probabilities.

By refining the call phases in this manner, the management system 110 may enhance the ability to accurately classify each part of a conversation. This classification may be utilized for determining appropriate intervention points and improving the quality of customer-agent interactions. These improvements may lead to better customer satisfaction, more effective cross-selling and up-selling strategies, and overall improved call handling processes.

As shown in FIG. 1D, and by reference number 135, the management system 110 may generate a session vector, a customer vector, and an agent activity vector based on the classified call phases. For example, the management system 110 may utilize the previously classified call phases to extract features relevant to a session (e.g., a call session), the customer, and agent activity. Specifically, the management system 110 may identify, from the classified call phases, session attributes, such as repeat caller status, session intent, emotion, unanswered questions, offer acceptance, offer rejection, hold time, and/or the like. The management system 110 may utilize the session attributes to generate a custom session embedding, and may convert the custom session embedding into the session vector (e.g., a hyper-contextual session vector).

The management system 110 may identify, from the classified call phases, customer attributes, such as phrase-level intent, customer reputation frequency, voice amplitude, pause frequency, profile information, and/or the like. The management system 110 may utilize the customer attributes to generate a custom customer embedding, and may convert the custom customer embedding into the customer vector (e.g., a hyper-contextual customer vector). The management system 110 may identify, from the classified call phases, agent activity attributes, such as phrase-level intent, agent reputation frequency, voice amplitude, pause frequency, complexity of solution, and/or the like. The management system 110 may utilize the agent activity attributes to generate a custom agent activity embedding, and may convert the custom agent activity embedding into the agent activity vector (e.g., a hyper-contextual agent activity vector).

The session vector, the customer vector, and the agent activity vector may collectively represent abstracted implementations of the ongoing call, which may enhance an ability of the management system 110 to make accurate, data-driven decisions regarding intervention points. The session vector may capture details, such as session priority, escalation likelihood, sentiment score, resolution progress, and/or the like. For example, the session priority may indicate an importance level of a session, which can aid in prioritizing resources effectively. The escalation likelihood may aid in predicting a potential need for higher-level intervention during a call. The customer vector may include characteristics like sentiment trend, communication efficiency, historical interaction metrics, account status, and/or the like. The sentiment trend may provide insights into an evolving mood of the customer throughout the call. The communication efficiency may be utilized to measure how effectively information is exchanged between the customer and the agent. The historical interaction metrics may provide a backdrop of the customer's previous interactions to better understand recurring issues or successful resolutions. The account status may provide a snapshot of customer-related profile data relevant to the call. The agent activity vector may include characteristics, such as response appropriateness, resolution attempt count, interaction tone, detailed solution complexity, and/or the like. The response appropriateness may evaluate the relevance and adequacy of the agent's responses to customer queries. The resolution attempt count may provide a valuable metric in assessing how many different solutions an agent has tried before concluding the call.

In some implementations, generating the session, customer, and agent activity vectors may include focusing on comprehensive feature extraction techniques. For example, the session vectors may consider repeat caller status and hold times using statistical methods such as median calculation and quantile regression. The customer vectors may incorporate voice amplitude measures extracted through Librosa library's amplitude envelopes and zero-crossing rates. The agent activity vectors may analyze solution complexity by text classification algorithms trained using labeled solution complexity data sets.

As shown in FIG. 1E, and by reference number 140, the management system 110 may estimate a time of intervention for agent intervention using the session vector, the customer vector, the agent activity vector, and a call phase time modifier. For example, the management system 110 may analyze the data encapsulated within the session vector, the customer vector, and the agent activity vector to generate a composite picture of the ongoing customer service call. In some implementations, the management system 110 may estimate the time of intervention for agent intervention using the composite picture of the ongoing customer service call and the call phase time modifier. The call phase time modifier may be derived from a relative time modifier and a call phase modifier, and may be utilized by the management system 110 to refine the estimation of the time of intervention. The relative time modifier may be calculated based on a statistical (e.g., a heuristic) analysis of call durations and the relative portions of the calls at which interventions are successful. The call phase modifier may assign a weight to each of the classified call phases relative to a time associated with a surrogate classifier model. By integrating these elements, the management system 110 may accurately predict an optimal time for the agent to intervene during the call to enhance the customer's experience and improve the likelihood of a successful intervention.

In some implementations, the management system 110 may process the session vector, with a first real-time model, to generate a session score. A real-time model may include a computational or simulation model that processes data and produces outputs almost instantaneously or within a very short time frame. A real-time model may employ advanced algorithms and technologies, such as machine learning, to rapidly process incoming data and provide actionable insights. The management system 110 may process the customer vector, with a second real-time model, to generate a customer perspective score. The management system 110 may process the agent activity vector, with a third real-time model, to generate an agent activity score. The management system 110 may process the utterances, the discourse labels, and the utterance timestamps, with a fourth real-time model, to generate a call phase time modifier score. The management system 110 may combine the session score, the customer perspective score, the agent activity score, and the call phase time modifier score to generate a final score. In some implementations, the management system 110 may combine the scores together to generate the final score (e.g., a time of intervention (TOI) score), as follows: TOI Score=w₁×Session Score+w₂×Customer Perspective Score+w₃×Agent Activity Score+Call Phase Time Modifier Score, where w₁, w₂, and w₃ are configurable weight values. The management system 110 may process the final score, the relative time modifier, and the call phase modifier to generate the estimate of the time of intervention.

In some implementations, for estimating the time of intervention, the management system 110 may compute the call phase time modifier by integrating the findings of heuristic analysis on historical successful interventions. The management system 110 may derive the relative time modifier from median call durations recorded in high-success cases. Additionally, call phase weights applied in the call phase modifier may be determined from detailed logistic regression models trained to predict phase significance based on past intervention outcomes.

In some implementations, the management system 110 may perform an exploratory analysis of historical calls to generate statistical time of intervention (TOI) estimates. This analysis may include multiple TOI metrics, such as an absolute TOI (e.g., time in seconds from the start of the call), a relative TOI (e.g., time as a percentage duration from the start of the call), an adjusted TOI (e.g., time in seconds after removing non-contextual elements like greetings), and a relative adjusted TOI (e.g., time as percentage duration after removing non-contextual elements). Segmentations of TOIs for each customer profile, intent, and agent combination may be performed, and these segmentations may be combined to derive a statistical TOI estimate.

As shown in FIG. 1F, and by reference number 145, the management system 110 may derive an optimal intervention point based on the time of intervention. For example, the management system 110 may analyze the estimated time of intervention to identify an optimal point for agent intervention during the customer service call. The optimal intervention point may be a most effective moment for the agent to intervene in order to enhance the customer interaction, improve service quality, and increase the likelihood of a positive outcome for the customer service call. By deriving an optimal intervention point, the management system 110 may ensure that interventions are made at strategic moments, reducing customer frustration and increasing the efficiency of the call-handling process.

In some implementations, the management system 110 may derive the optimal intervention point based on the time of intervention by incorporating historical and real-time call data. This may ensure that agent interventions are timely and effective, leading to increased customer satisfaction and call resolution rates. Additionally, or alternatively, the management system 110 may utilize statistical analysis and machine learning models to calculate the optimal intervention point. This may ensure that the agent's engagement occurs at the most beneficial time for optimal call handling and enhanced customer relations. In some implementations, the management system 110 may utilize the calculated TOI score and the classified call phases to derive the optimal intervention point. For example, if the TOI score is greatest between an agent summarization phase and an agent resolution phase, the management system 110 may determine that the optimal intervention point is between the agent summarization phase and the agent resolution phase (e.g., when the TOI score is the greatest).

As shown in FIG. 1G, and by reference number 150, the management system 110 may provide a recommendation for agent intervention during the customer service call at the optimal intervention point. For example, the management system 110 may generate an intervention recommendation (e.g., via a text alert, an audio alert, a tactile alert, and/or a combination of the aforementioned alerts) based on the analysis of the estimated time of intervention, the session vector, the customer vector, the agent activity vector, and the call phase time modifier. The management system 110 may provide the recommendation to the agent via the user device 105 associated with the agent, enabling the agent to intervene in the customer call at the most effective moment to enhance customer interaction, improve service quality, and increase the likelihood of a positive outcome for the customer service call. By providing this recommendation, the management system 110 may ensure that interventions are made at strategic moments, thereby reducing customer frustration and increasing call-handling efficiency.

Additionally, or alternatively, the user device 105 may receive the intervention recommendation from the management system 110, allowing the agent to react with precision based on accurate timing computation. The precision timing ensures that the agent's actions align perfectly with the optimal intervention point, contributing to seamless interaction quality. Additionally, or alternatively, the recommendations provided by the management system 110 may help in reducing customer frustration and increasing call-handling efficiency. The management system 110 may provide an optimized customer service process and improved evaluation metrics via evidence-based intervention recommendations. By automating this aspect of the call-handling process, the management system 110 streamlines intervention timings, reduces cognitive load on agents, and minimizes the likelihood of errors due to subjective judgment.

In this way, the management system 110 identifies a time of intervention during a customer call. For example, the management system 110 may optimize the timing of agent interventions during customer service calls through data-driven techniques. The management system 110 may enhance the objectivity and precision of agent interventions during customer service calls by utilizing algorithmically-computed intervention points. The approach utilized by the management system 110 may account for the dynamic variables present in each call, including unique customer and agent behaviors, and real-time call flow. The management system 110 may provide an optimized customer service process and improved evaluation metrics via evidence-based intervention recommendations. By automating this aspect of the call handling process, the management system 110 may streamline intervention timings, reduce cognitive load on agents, and minimize the likelihood of errors due to subjective judgment. Thus, the management system 110 may conserve computing resources, networking resources, and/or other resources that would have otherwise been consumed by failing to provide appropriate interventions at the correct times, having offers consistently rejected by customers, handling customer complaints and lost customers, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

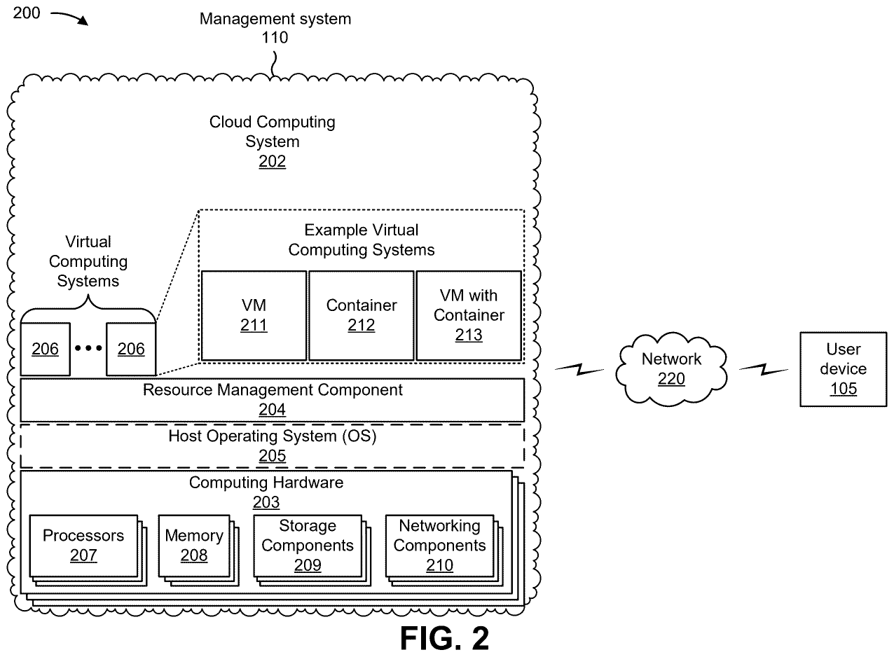

FIG. 2 is a diagram of an example environment 200 in which systems and/or methods described herein may be implemented. As shown in FIG. 2, the environment 200 may include the management system 110, which may include one or more elements of and/or may execute within a cloud computing system 202. The cloud computing system 202 may include one or more elements 203-213, as described in more detail below. As further shown in FIG. 2, the environment 200 may include a user device 105 and a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

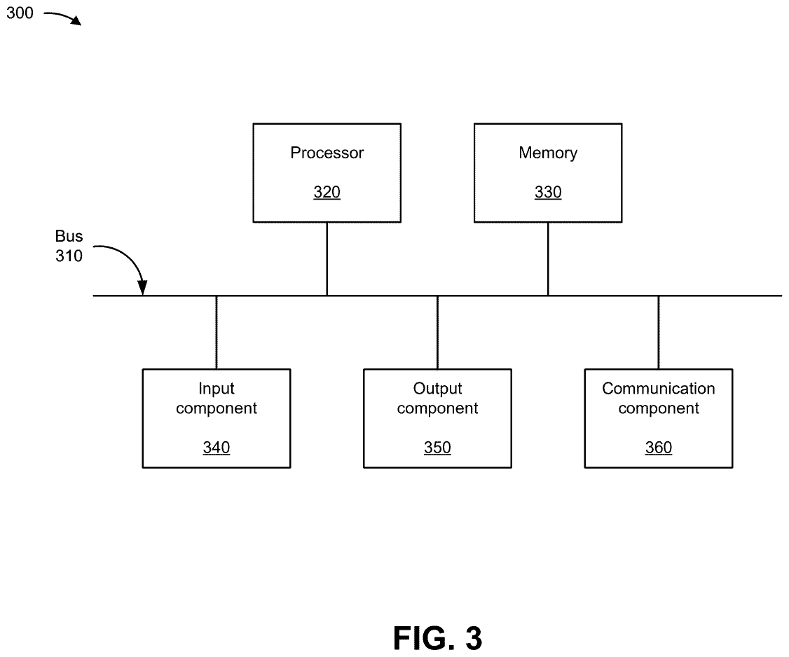

Although the management system 110 may include one or more elements 203-213 of the cloud computing system 202, may execute within the cloud computing system 202, and/or may be hosted within the cloud computing system 202, in some implementations, the management system 110 may not be cloud-based (e.g., may be implemented outside of a cloud computing system) or may be partially cloud-based. For example, the management system 110 may include one or more devices that are not part of the cloud computing system 202, such as a device 300 of FIG. 3, which may include a standalone server or another type of computing device. The management system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105 and/or the management system 110. In some implementations, the user device 105 and/or the management system 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

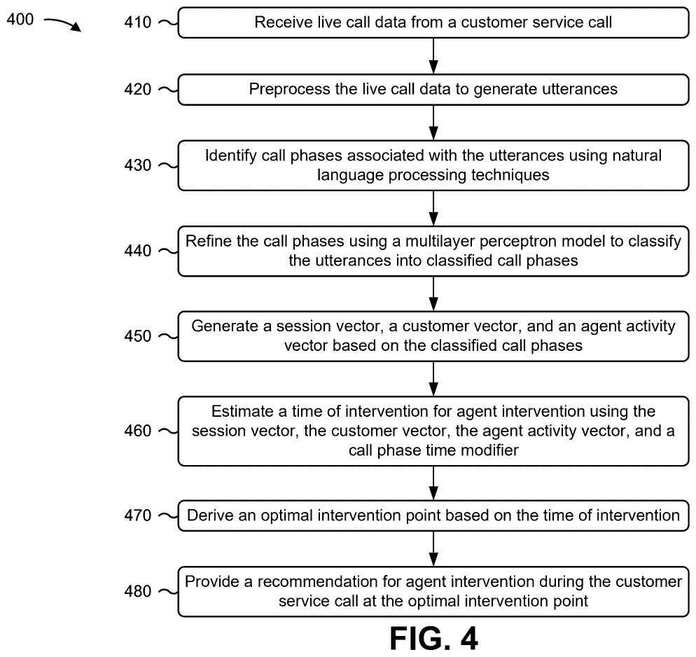

FIG. 4 depicts a flowchart of an example process 400 for identifying a time of intervention during a customer call. In some implementations, one or more process blocks of FIG. 4 may be performed by a device (e.g., the management system 110). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving live call data from a customer service call (block 410). For example, the device may receive live call data from a customer service call, as described above.

As further shown in FIG. 4, process 400 may include preprocessing the live call data to generate utterances (block 420). For example, the device may preprocess the live call data to generate utterances, as described above.

As further shown in FIG. 4, process 400 may include identifying call phases associated with the utterances using natural language processing techniques (block 430). For example, the device may identify call phases associated with the utterances using natural language processing techniques, as described above. In some implementations, the natural language processing techniques analyze the utterances for greeting phases, customer problem explanation phases, agent resolution phases, and customer acceptance or rejection phases.

As further shown in FIG. 4, process 400 may include refining the call phases using a multilayer perceptron model to classify the utterances into classified call phases (block 440). For example, the device may refine the call phases using a multilayer perceptron model to classify the utterances into classified call phases, as described above. In some implementations, the multilayer perceptron model is trained using historical call data to classify the utterances into the classified call phases.

As further shown in FIG. 4, process 400 may include generating a session vector, a customer vector, and an agent activity vector based on the classified call phases (block 450). For example, the device may generate a session vector, a customer vector, and an agent activity vector based on the classified call phases, as described above. In some implementations, the session vector includes one or more of a repeat caller status attribute, a session intent attribute, an emotion attribute, an unanswered question attribute, an offer acceptance attribute, an offer rejection attribute, or a hold time attribute. In some implementations, the customer vector includes one or more of a phrase-level intent attribute, a customer reputation frequency attribute, a voice amplitude attribute, a pause frequency attribute, or a profile information attribute. In some implementations, the agent activity vector includes one or more of a phrase-level intent attribute, an agent reputation frequency attribute, a voice amplitude attribute, a pause frequency attribute, or a complexity of solution attribute.

As further shown in FIG. 4, process 400 may include estimating a time of intervention for agent intervention using the session vector, the customer vector, the agent activity vector, and a call phase time modifier (block 460). For example, the device may estimate a time of intervention for agent intervention using the session vector, the customer vector, the agent activity vector, and a call phase time modifier, as described above. In some implementations, the call phase time modifier is calculated based on a relative time modifier and a call phase modifier. In some implementations, the relative time modifier is derived from a statistical analysis of call durations and relative portions of calls at which interventions are successful. In some implementations, the call phase modifier assigns a weight to each of the classified call phases relative to a time associated with a surrogate classifier model.

As further shown in FIG. 4, process 400 may include deriving an optimal intervention point based on the time of intervention (block 470). For example, the device may derive an optimal intervention point based on the time of intervention, as described above.

As further shown in FIG. 4, process 400 may include providing a recommendation for agent intervention during the customer service call at the optimal intervention point (block 480). For example, the device may provide a recommendation for agent intervention during the customer service call at the optimal intervention point, as described above.

In some implementations, process 400 includes performing an exploratory analysis of historical calls to generate statistical time of intervention estimates based on segmented data of customer profiles, intents, and agent interactions. In some implementations, performing the exploratory analysis of the historical calls includes analyzing the historical calls for an absolute time of intervention estimate, a relative time of intervention estimate, an adjusted time of intervention estimate, and a relative adjusted time of intervention estimate.

In some implementations, process 400 includes adjusting the call phases by removing noise and non-contextual utterances from the call phases. In some implementations, process 400 includes providing real-time updates and feedback to an agent based on the optimal intervention point during the customer service call.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, live call data from a customer service call;
preprocessing, by the device, the live call data to generate utterances;
identifying, by the device, call phases associated with the utterances using natural language processing techniques;
refining, by the device, the call phases using a multilayer perceptron model to classify the utterances into classified call phases;
generating, by the device, a session vector, a customer vector, and an agent activity vector based on the classified call phases;
estimating, by the device, a time of intervention for agent intervention using the session vector, the customer vector, the agent activity vector, and a call phase time modifier;
deriving, by the device, an optimal intervention point based on the time of intervention; and
providing, by the device, a recommendation for agent intervention during the customer service call at the optimal intervention point.

2. The method of claim 1, wherein the natural language processing techniques analyze the utterances for greeting phases, customer problem explanation phases, agent resolution phases, and customer acceptance or rejection phases.

3. The method of claim 1, further comprising:
performing an exploratory analysis of historical calls to generate statistical time of intervention estimates based on segmented data of customer profiles, intents, and agent interactions.

4. The method of claim 3, wherein performing the exploratory analysis of the historical calls comprises:
analyzing the historical calls for an absolute time of intervention estimate, a relative time of intervention estimate, an adjusted time of intervention estimate, and a relative adjusted time of intervention estimate.

5. The method of claim 1, wherein the session vector includes one or more of a repeat caller status attribute, a session intent attribute, an emotion attribute, an unanswered question attribute, an offer acceptance attribute, an offer rejection attribute, or a hold time attribute.

6. The method of claim 1, wherein the customer vector includes one or more of a phrase-level intent attribute, a customer reputation frequency attribute, a voice amplitude attribute, a pause frequency attribute, or a profile information attribute.

7. The method of claim 1, wherein the agent activity vector includes one or more of a phrase-level intent attribute, an agent reputation frequency attribute, a voice amplitude attribute, a pause frequency attribute, or a complexity of solution attribute.

8. A device, comprising:
one or more processors configured to:
receive live call data from a customer service call;
preprocess the live call data to generate utterances;
identify call phases associated with the utterances using natural language processing techniques,
wherein the natural language processing techniques analyze the utterances for greeting phases, customer problem explanation phases, agent resolution phases, and customer acceptance or rejection phases;
refine the call phases using a multilayer perceptron model to classify the utterances into classified call phases;
generate a session vector, a customer vector, and an agent activity vector based on the classified call phases;
estimate a time of intervention for agent intervention using the session vector, the
customer vector, the agent activity vector, and a call phase time modifier;
derive an optimal intervention point based on the time of intervention; and
provide a recommendation for agent intervention during the customer service call at the optimal intervention point.

9. The device of claim 8, wherein the call phase time modifier is calculated based on a relative time modifier and a call phase modifier.

10. The device of claim 9, wherein the relative time modifier is derived from a statistical analysis of call durations and relative portions of calls at which interventions are successful.

11. The device of claim 9, wherein the call phase modifier assigns a weight to each of the classified call phases relative to a time associated with a surrogate classifier model.

12. The device of claim 8, wherein the one or more processors are further configured to:
adjust the call phases by removing noise and non-contextual utterances from the call phases.

13. The device of claim 8, wherein the multilayer perceptron model is trained using historical call data to classify the utterances into the classified call phases.

14. The device of claim 8, wherein the one or more processors are further configured to:
provide real-time updates and feedback to an agent based on the optimal intervention point during the customer service call.

15. A non-transitory computer-readable medium storing a set of instructions, the set of instructions comprising:
one or more instructions that, when executed by one or more processors of a device, cause the device to:
receive live call data from a customer service call;
preprocess the live call data to generate utterances;
identify call phases associated with the utterances using natural language processing techniques;
refine the call phases using a multilayer perceptron model to classify the utterances into classified call phases;
generate a session vector, a customer vector, and an agent activity vector based on the classified call phases;
estimate a time of intervention for agent intervention using the session vector, the customer vector, the agent activity vector, and a call phase time modifier;
derive an optimal intervention point based on the time of intervention;
provide a recommendation for agent intervention during the customer service call at the optimal intervention point; and
provide real-time updates and feedback to an agent based on the optimal intervention point during the customer service call.

16. The non-transitory computer-readable medium of claim 15, wherein the one or more instructions further cause the device to:
perform an exploratory analysis of historical calls to generate statistical time of intervention estimates based on segmented data of customer profiles, intents, and agent interactions.

17. The non-transitory computer-readable medium of claim 16, wherein the one or more instructions, that cause the device to perform the exploratory analysis of the historical calls, cause the device to:
analyze the historical calls for an absolute time of intervention estimate, a relative time of intervention estimate, an adjusted time of intervention estimate, and a relative adjusted time of intervention estimate.

18. The non-transitory computer-readable medium of claim 15, wherein the call phase time modifier is calculated based on a relative time modifier and a call phase modifier.

19. The non-transitory computer-readable medium of claim 15, wherein the one or more instructions further cause the device to:
adjust the call phases by removing noise and non-contextual utterances from the call phases.

20. The non-transitory computer-readable medium of claim 15, wherein the multilayer perceptron model is trained using historical call data to classify the utterances into the classified call phases.
